(19) United States
(12) Patent Application Publication
(10) Pub. No.: US 2007/0136069 A1
(43) Pub. Date: Jun. 14, 2007

(54) Method and system for customizing speech recognition in a mobile vehicle communication system

(75) Inventors: Shpetim S. Veliu, Livonia, MI (US); Hitan S. Kamdar, Utica, MI (US); Anthony J. Sumcad, Southfield, MI (US); Russell A. Patenaude, Macomb Township, MI (US); Brad T. Reeser, Lake Orion, MI (US); Rathinavelu Chengalvarayan, Naperville, IL (US); Scott M. Pennock, Lake Orion, MI (US); Timothy J. Grost, Clarkston, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: General Motors Corporation

(21) Appl. No.: 11/301,949

(22) Filed: Dec. 13, 2005

(51) Int. Cl. G10L 21/00

(52) U.S. Cl. 704/270

(57) ABSTRACT

A method of customizing speech recognition in a mobile vehicle communication system is provided. A speech input is received at a telematics unit in communication with a call center, the speech input associated with a failure mode notification. The speech input is recorded at the telematics unit then forwarded to the call center via a wireless network based on the failure mode notification. At least one user-specific voice-recognition set is then received from the call center in response to the failure mode notification, wherein the user-specific voice-recognition set has been updated with the speech input. Systems and programs of customizing speech recognition in a mobile vehicle communication system are also provided.

### FIELD OF THE INVENTION

This invention relates generally to customizing speech recognition in a mobile vehicle communication system. More specifically, the invention relates to a method and system for customizing speech recognition according to speech regions based on instances of failed speech recognition within a mobile vehicle communication system.

### BACKGROUND OF THE INVENTION

The users of a mobile vehicle communication system can be as varied as the regions that the system serves. Moreover, each user will speak (i.e. give voice commands) to the system in a unique, user-specific manner. A user from the southern United States, for example, will speak her voice commands in a manner unique from the voice commands that a user from the United Kingdom or China will speak.

Currently speech-recognition engines respond best to voice commands spoken in a standardized manner. This standardized manner comprises the speech patterns of native North American speakers and speech recognition is based on an average of speech input. Some speech utterances are difficult to match to existing speech recognition engines. In such cases, the recognition engine performs a best-fit match against its internal lexicon. This results in a list of words that are close to the utterance. The first word on the list is presented to the user for approval. If it is not the desired word, the next word on the list is presented until a word is finally approved by the user. These speech recognition failures, however, are not tracked or recorded by current engines in mobile communication systems. Moreover, current speech recognition engines in mobile communication systems do not adjust the speech recognition based on these instances of failed speech recognition. Additionally, the speech recognition failures are not used to generate or provide new speech recognition sets that are based on geographic region-specific speech recognition failures.

It is an object of this invention, therefore, to overcome the obstacles described above.

### SUMMARY OF THE INVENTION

One aspect of the present invention provides a method of customizing speech recognition in a mobile vehicle communication system. A speech input is received at a telematics unit in communication with a call center, the speech input associated with a failure mode notification. The speech input is recorded at the telematics unit and forwarded to the call center via a wireless network based on the failure mode notification. At least one user-specific voice-recognition set is then received from the call center in response to the failure mode notification, wherein the user-specific voice-recognition set has been updated with the speech input. The user-specific voice recognition set is selected based on registration information of the telematics unit.

A machine instruction responsive to the speech input is also determined and the user-specific voice-recognition set is updated based on the determined machine instruction and speech input. A voice recognition algorithm is also received at the telematics unit from the call center, wherein the voice recognition algorithm incorporates data from the speech input. The user-specific voice-recognition set is associated with a geographic designation. A geographic region of the telematics unit is determined and a geographically-specific voice recognition set is updated based on the determined geographic region and speech input. The geographically-specific voice recognition algorithm is received from the call center, wherein the geographically-specific voice recognition algorithm incorporates data from the speech input.

Another aspect of the present invention provides a method of customizing speech recognition in a mobile vehicle communication system. A failure mode notification is received from a telematics unit via a wireless network, wherein the failure mode notification includes a recorded speech input that is associated with a machine instruction. A user-specific voice recognition set is updated with the speech input, wherein the updating comprises associating the speech input with a geographic designation. The updated user-specific voice recognition set is forwarded to the telematics unit. The geographic designation for the telematics unit is created based on a geographic location of the telematics unit, registration information of the telematics unit; and a global positioning location of the telematics unit. A voice recognition algorithm is modified based on data from the speech input and forwarded to the telematics unit.

Yet another aspect of the present invention comprises a computer usable medium including a program to customize speech recognition in a mobile vehicle communication system. The program comprises computer program code that receives a failure mode notification from a telematics unit via a wireless network, wherein the failure mode notification includes a recorded speech input, computer program code that associates the speech input with a machine instruction, computer program code that updates a user-specific voice recognition set with the speech input, wherein the user-specific voice recognition set is associated with a geographic region; and computer program code that forwards the updated user-specific voice recognition set to the telematics unit.

The program further comprises computer program code that modifies a voice recognition algorithm based on data from the recorded speech input, as well as computer program code that forwards the modified voice recognition algorithm to the telematics unit. The program further comprises computer program code that selects the user-specific voice recognition set based on registration information of the telematics unit.

The program also comprises means for determining a machine instruction responsive to the speech input, means for creating the geographic designation for the telematics unit, means for determining a geographic location or region of the telematics unit, means for determining registration information of the telematics unit, means for determining a global positioning location of the telematics unit and means for selecting the user-specific voice recognition set based on the geographic location or region.

The aforementioned and other features and advantages of the invention will become further apparent from the following detailed description of the presently preferred examples, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 illustrates a system for customizing speech-recognition in a mobile vehicle communication system, in accordance with one example of the current invention;

FIG. 2 illustrates a system for customizing speech-recognition in a mobile vehicle communication system in accordance with another example of the current invention;

FIG. 3 illustrates a method for customizing speech-recognition in a mobile vehicle communication system, in accordance with one example of the current invention; and

FIG. 4 illustrates a method for customizing speech-recognition in a mobile vehicle communication system, in accordance with another example of the current invention.

### DETAILED DESCRIPTION OF THE PRESENTLY PREFERRED EXEMPLARY EMBODIMENTS

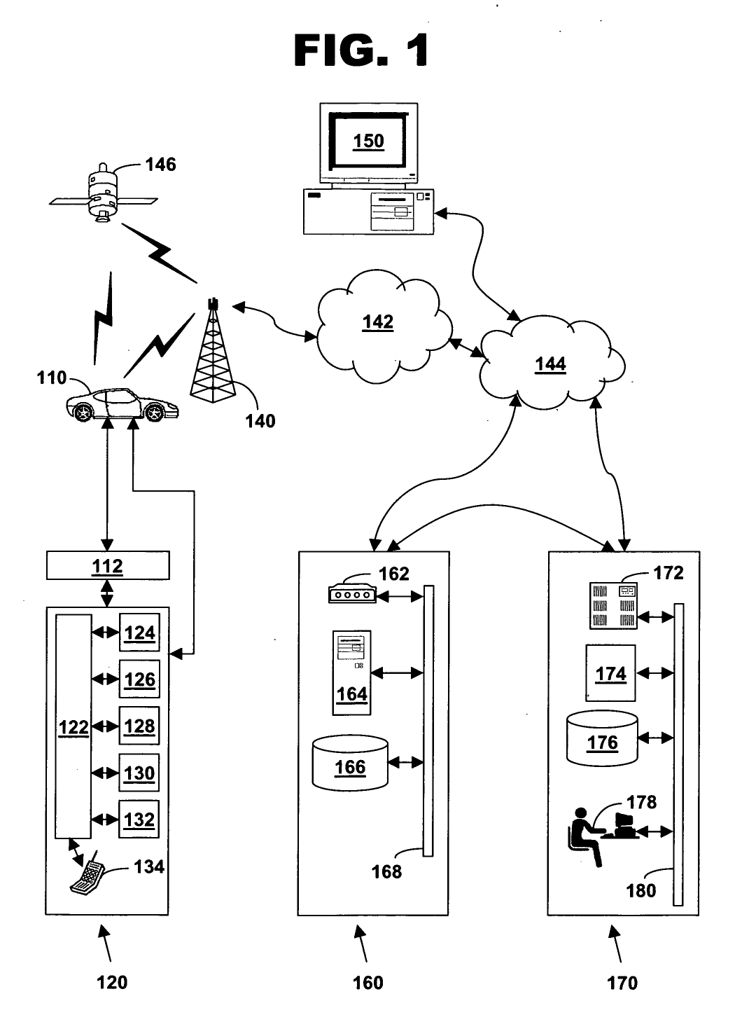

FIG. 1 illustrates one example of a mobile vehicle communication system (MVCS) 100 for customizing speech recognition. MVCS 100 includes a mobile vehicle communication unit (MVCU) 110, a vehicle communication network 112, a telematics unit 120, one or more wireless carrier systems 140, one or more communication networks 142, one or more land networks 144, one or more satellite broadcast systems 146, one or more client, personal, or user computers 150, one or more web-hosting portals 160, and one or more call centers 170. In one example, MVCU 110 is implemented as a mobile vehicle equipped with suitable hardware and software for transmitting and receiving voice and data communications. MVCS 100 could include additional components not relevant to the present discussion. Mobile vehicle communication systems and telematics units are known in the art.

MVCU 110 is also referred to as a mobile vehicle in the discussion below. In operation, mobile vehicle 110 could be implemented as a motor vehicle, a marine vehicle, or as an aircraft. Mobile vehicle 110 could include additional components not relevant to the present discussion.

Vehicle communication network 112 sends signals to various units of equipment and systems within vehicle 110 to perform various functions such as monitoring the operational state of vehicle systems, collecting and storing data from the vehicle systems, providing instructions, data and programs to various vehicle systems, and calling from telematics unit 120. In facilitating interactions among the various communication and electronic modules, vehicle communication network 112 utilizes interfaces such as controller-area network (CAN), Media Oriented System Transport (MOST), Local Interconnect Network (LIN), Ethernet (10 base T, 100 base T), International Organization for Standardization (ISO) Standard 9141, ISO Standard 11898 for high-speed applications, ISO Standard 11519 for lower speed applications, and Society of Automotive Engineers (SAE) standard J1850 for higher and lower speed applications. In one example, vehicle communication network 112 is a direct connection between connected devices.

MVCU 110, via telematics unit 120, sends to and receives radio transmissions from wireless carrier system 140. Wireless carrier system 140 is implemented as any suitable system for transmitting a signal from MVCU 110 to communication network 142.

Telematics unit 120 includes a processor 122 connected to a wireless modem 124, a global positioning system (GPS) unit 126, an in-vehicle memory 128, a microphone 130, one or more speakers 132, and an embedded or in-vehicle mobile phone 134. In other examples, telematics unit 120 is implemented without one or more of the above listed components such as, for example, speakers 132. Telematics unit 120 could include additional components not relevant to the present discussion. Telematics unit 120 is one example of a vehicle module.

In one example, processor 122 is implemented as a microcontroller, controller, host processor, or vehicle communications processor. In one example, processor 122 is a digital signal processor. In another example, processor 122 is implemented as an application-specific integrated circuit. In another example, processor 122 is implemented as a processor working in conjunction with a central processing unit performing the function of a general-purpose processor. GPS unit 126 provides longitude and latitude coordinates of the vehicle responsive to a GPS broadcast signal received from one or more GPS satellite broadcast systems (not shown). In-vehicle mobile phone 134 is a cellular-type phone such as, for example, a digital, dual-mode (e.g., analog and digital), dual-band, multi-mode, or multi-band cellular phone.

Processor 122 executes various computer programs that control programming and operational modes of electronic and mechanical systems within mobile vehicle 110. Processor 122 controls communications (e.g., call signals) between telematics unit 120, wireless carrier system 140, and call center 170. Additionally, processor 122 controls reception of communications from satellite broadcast system 146. In one example, a voice-recognition application is installed in processor 122 that can translate human voice input through microphone 130 to digital signals. In accordance with the present invention, this voice-recognition application customizes recognition of particular sounds based on interaction with an individual user. Processor 122 generates and accepts digital signals transmitted between telematics unit 120 and vehicle communication network 112 that is connected to various electronic modules in the vehicle. In one example, these digital signals activate programming modes and operation modes, as well as provide for data transfers such as, for example, data over voice channel communication. Signals from processor 122 could be translated into voice messages and sent out through speaker 132.

Wireless carrier system 140 is a wireless communications carrier or a mobile telephone system and transmits to and receives signals from one or more mobile vehicle 110. Wireless carrier system 140 incorporates any type of telecommunications in which electromagnetic waves carry signals over part of or the entire communication path. In one example, wireless carrier system 140 is implemented as any type of broadcast communication in addition to satellite broadcast system 146. In another example, wireless carrier system 140 provides broadcast communication to satellite broadcast system 146 for download to mobile vehicle 110. In one example, wireless carrier system 140 connects communication network 142 to land network 144 directly. In another example, wireless carrier system 140 connects communication network 142 to land network 144 indirectly via satellite broadcast system 146.

Satellite broadcast system 146 transmits radio signals to telematics unit 120 within mobile vehicle 110. In one example, satellite broadcast system 146 broadcasts over a spectrum in the “S” band of 2.3 GHz that has been allocated by the U.S. Federal Communications Commission for nationwide broadcasting of satellite-based Digital Audio Radio Service (SDARS).

In operation, broadcast services provided by satellite broadcast system 146 are received by telematics unit 120 located within mobile vehicle 110. In one example, broadcast services include various formatted programs based on a package subscription obtained by the user and managed by telematics unit 120. In another example, broadcast services include various formatted data packets based on a package subscription obtained by the user and managed by call center 170. In an example, processor 122 implements data packets received by telematics unit 120.

Communication network 142 includes services from one or more mobile telephone switching offices and wireless networks. Communication network 142 connects wireless carrier system 140 to land network 144. Communication network 142 is implemented as any suitable system or collection of systems for connecting wireless carrier system 140 to mobile vehicle 110 and land network 144.

Land network 144 connects communication network 142 to computer 150, web-hosting portal 160, and call center 170. In one example, land network 144 is a public-switched telephone network. In another example, land network 144 is implemented as an Internet protocol (IP) network. In other examples, land network 144 is implemented as a wired network, an optical network, a fiber network, a wireless network, or a combination thereof. Land network 144 is connected to one or more landline telephones. Communication network 142 and land network 144 connect wireless carrier system 140 to web-hosting portal 160 and call center 170.

Client, personal, or user computer 150 includes a computer usable medium to execute Internet browser and Internet-access computer programs for sending and receiving data over land network 144 and, optionally, wired or wireless communication networks 142 to web-hosting portal 160. Computer 150 sends user preferences to web-hosting portal 160 through a web-page interface using communication standards such as hypertext transport protocol, or transport-control protocol and Internet protocol. In one example, the data includes directives to change certain programming and operational modes of electronic and mechanical systems within mobile vehicle 110.

In operation, a client utilizes computer 150 to initiate setting or re-setting of user preferences for mobile vehicle 110. User-preference data from client-side software is transmitted to server-side software of web-hosting portal 160. In an example, user-preference data is stored at web-hosting portal 160. In one example, the user-preference data indicates a geographic-region specific speech engine to use for speech recognition with telematics unit 120. The user may select a speech recognition set and algorithm for his home accent, e.g. New York, U.S. southern, British, Chinese, Indian, etc. In one example of the invention, the speech recognition set is chosen when the user registers MVCU 110. For example, the user registers as a user of MVCU 110 with an address in New York and a speech recognition set specific to New York is automatically selected for the user's MVCU 110. Alternatively, for example, the user registers with an address in New York but manually selects a speech recognition set specific to a Chinese accent at registration.

Web-hosting portal 160 includes one or more data modems 162, one or more web servers 164, one or more databases 166, and a network system 168. Web-hosting portal 160 is connected directly by wire to call center 170, or connected by phone lines to land network 144, which is connected to call center 170. In an example, web-hosting portal 160 is connected to call center 170 utilizing an IP network. In this example, both components, web-hosting portal 160 and call center 170, are connected to land network 144 utilizing the IP network. In another example, web-hosting portal 160 is connected to land network 144 by one or more data modems 162. Land network 144 sends digital data to and receives digital data from data modem 162, data that is then transferred to web server 164. Data modem 162 could reside inside web server 164. Land network 144 transmits data communications between web-hosting portal 160 and call center 170.

Web server 164 receives data from user computer 150 via land network 144. In alternative examples, computer 150 includes a wireless modem to send data to web-hosting portal 160 through a wireless communication network 142 and a land network 144. Data is received by land network 144 and sent to one or more web servers 164. Web server 164 sends to or receives from one or more databases 166 data transmissions via network system 168. Web server 164 includes computer applications and files for managing and storing personalization settings supplied by the client, such as door lock/unlock behavior, radio station preset selections, climate controls, custom button configurations, theft alarm settings and recorded speech patterns. For each client, the web server potentially stores hundreds of preferences for wireless vehicle communication, networking, maintenance, and diagnostic services for a mobile vehicle.

In one example, one or more web servers 164 are networked via network system 168 to distribute user-preference data among its network components such as database 166. In an example, database 166 is a part of or a separate computer from web server 164. Web server 164 sends data transmissions with user preferences to call center 170 through land network 144.

Call center 170 is a location where many calls are received and serviced at the same time, or where many calls are sent at the same time. In one example, the call center is a telematics call center, facilitating communications to and from telematics unit 120 in mobile vehicle 110. In another example, the call center is a voice call center, providing verbal communications between an advisor in the call center and a subscriber in a mobile vehicle. In another example, the call center contains each of these functions. In other examples, call center 170 and web-hosting portal 160 are located in the same or different facilities.

Call center 170 contains one or more voice and data switches 172, one or more communication services managers 174, one or more communication services databases 176, one or more communication services advisors 178, and one or more network systems 180.

Switch 172 of call center 170 connects to land network 144. Switch 172 transmits voice or data transmissions from call center 170, and receives voice or data transmissions from telematics unit 120 in mobile vehicle 110 through wireless carrier system 140, communication network 142, and land network 144. Switch 172 receives data transmissions from and sends data transmissions to one or more web-hosting portals 160. Switch 172 receives data transmissions from or sends data transmissions to one or more communication services managers 174 via one or more network systems 180.

Communication services manager 174 is any suitable hardware and software capable of providing requested communication services to telematics unit 120 in mobile vehicle 110. Communication services manager 174 sends to or receives from one or more communication services databases 176 data transmissions via network system 180. Communication services manager 174 sends to or receives from one or more communication services advisors 178 data transmissions via network system 180. Communication services database 176 sends to or receives from communication services advisor 178 data transmissions via network system 180. Communication services advisor 178 receives from or sends to switch 172 voice or data transmissions.

Communication services manager 174 provides one or more of a variety of services including initiating data over voice channel wireless communication, enrollment services, navigation assistance, directory assistance, roadside assistance, business or residential assistance, information services assistance, emergency assistance, and communications assistance. Communication services manager 174 receives service-preference requests for a variety of services from the client via computer 150, web-hosting portal 160, and land network 144. Communication services manager 174 transmits user-preference and other data such as, for example, primary diagnostic script or updated speech engines and speech recognition sets to telematics unit 120 in mobile vehicle 110 through wireless carrier system 140, communication network 142, land network 144, voice and data switch 172, and network system 180. Communication services manager 174 stores or retrieves data and information from communications services database 176. Communication services manager 174 provides requested information to communication services advisor 178. The communications service manager 174 contains one or more analog or digital modems. Communications service manager 174 manages speech recognition, sending and receiving speech input from telematics unit 120 and managing appropriate voice/speech recognition algorithms.

In one example, communication services advisor 178 is implemented as a real advisor. In an example, a real advisor is a human being in verbal communication with a user or subscriber (e.g., a client) in mobile vehicle 110 via telematics unit 120. In another example, communication services advisor 178 is implemented as a virtual advisor/automaton. For example, a virtual advisor is implemented as a synthesized voice interface responding to requests from telematics unit 120 in mobile vehicle 110.

Communication services advisor 178 provides services to telematics unit 120 in mobile vehicle 110. Services provided by communication services advisor 178 include enrollment services, navigation assistance, real-time traffic advisories, directory assistance, roadside assistance, business or residential assistance, information services assistance, emergency assistance, automated vehicle diagnostic function, and communications assistance. Communication services advisor 178 communicates with telematics unit 120 in mobile vehicle 110 through wireless carrier system 140, communication network 142, and land network 144 using voice transmissions, or through communication services manager 174 and switch 172 using data transmissions. Switch 172 selects between voice transmissions and data transmissions.

In operation, an incoming call is routed to telematics unit 120 within mobile vehicle 110 from call center 170. In one example, the call is routed to telematics unit 120 from call center 170 via land network 144, communication network 142, and wireless carrier system 140. In another example, an outbound communication is routed to telematics unit 120 from call center 170 via land network 144, communication network 142, wireless carrier system 140, and satellite broadcast system 146. In this example, an inbound communication is routed to call center 170 from telematics unit 120 via wireless carrier system 140, communication network 142, and land network 144.

In accordance with one example of the present invention, MVCS 100 serves as a system for customizing speech recognition to an individual's speech patterns. One or more users of mobile vehicles 110 contact call center 170 with speech input. Speech input includes but is not limited to typical voice commands (“dial phone number 312-555-1212”,“lookup address”, etc).

On occasions in which speech recognition engines fail to recognize a given input, the speech recognition algorithms may be updated to generate a better match to speech inputs that are geographically specific. Such occasions of speech recognition failure comprise failure to match the speech input to an existing set of recognized, previously recorded inputs and/or failure to associate the speech input with a given machine instruction. For example, users from the Southern region of the United States may utter ‘doll’ for ‘dial’. These failed speech recognition attempts, and the original speech input associated with the failed speech recognition attempts, are uploaded to a database, such as database 176 and cross-referenced by region in order to generate geographically specific speech recognition engines.

Misrecognition by the speech recognition algorithm may occur when a user utters a string, such as, for example “313-555-1212”. The speech recognition algorithm may interpret the string as “312-555-1212” and repeat said interpreted string to the user for verification. The user may re-utter the original string “313-555-1212” and the speech recognition algorithm may re-interpret the string again as “312-555-1212”. This exchange between the user and the speech recognition algorithm may occur for a number of predetermined cycles, such as, for example, three cycles. In this example the originally uttered string, “313-555-1212” and the misinterpreted string “312-555-1212” are uploaded to database 176 and interpreted, A speech algorithm adjusted so that it accommodates the misinterpreted digit is downloaded to the telematics unit 120.

Computer program code containing suitable instructions for speech recognition engines and for customization of speech recognition sets reside in part at call center 170, mobile vehicle 110, or telematics unit 120 or at any suitable combination of these locations. For example, a program including computer program code to customize speech recognition patterns, according to geographic region or to other criteria, resides at call center 170. Meanwhile, a program including computer program code to receive and record speech input from an individual user resides at telematics unit 120 or at the mobile phone 134 of telematics unit 120. In addition, a default speech recognition set may reside at telematics unit 120.

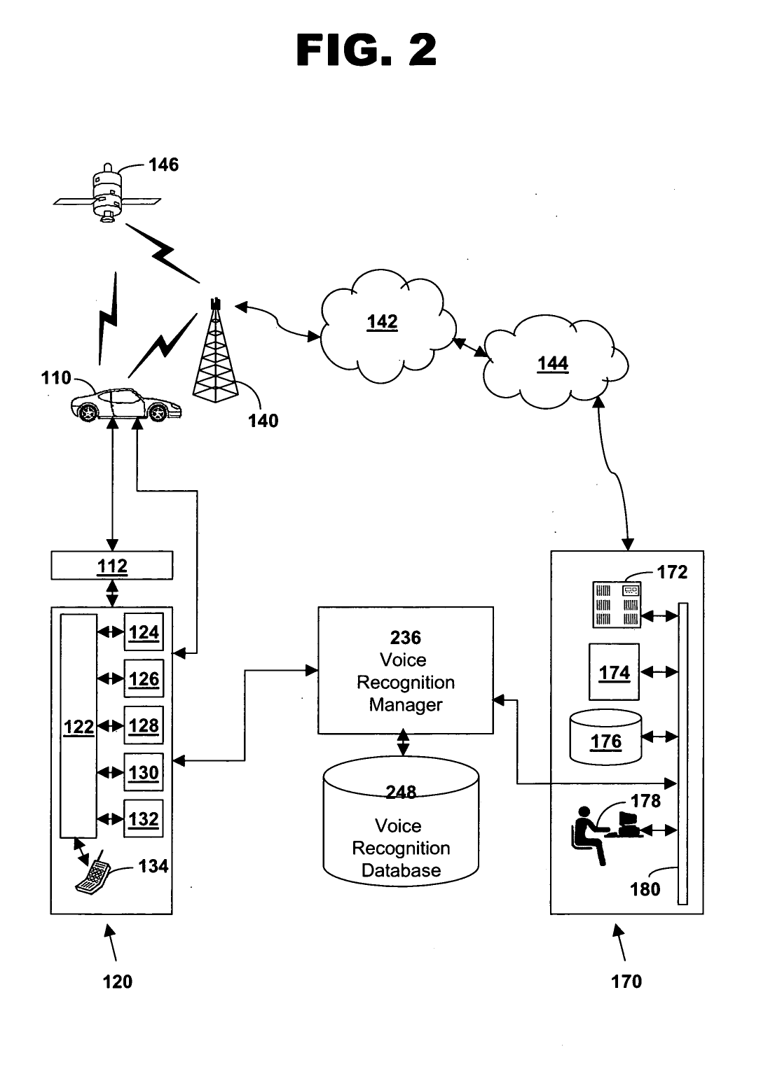

FIG. 2 illustrates another example of a mobile vehicle communication system (MVCS) 200 for customizing speech recognition patterns. In some examples of the invention, the components shown in FIG. 2 are also used in conjunction with one or more of the components of mobile vehicle communication system 100, above.

System 200 includes a vehicle network 112, telematics unit 120, and call center 170 as well as one or more of their separate components, as described above with reference to FIG. 1. System 200 further comprises a voice recognition manager 236 and a voice recognition database 248. In the example of FIG. 2, voice recognition manager 236 and voice recognition database 248 could be stored in a separate dedicated system for managing voice recognition.

Voice recognition manager 236 is any suitable hardware and software capable of receiving speech input for voice recognition, matching speech input voice recognition sets with appropriate voice recognition algorithms, storing received speech input, configuring voice recognition algorithms and/or responding to voice commands at telematics unit 120. In other examples, voice recognition manager 236 also coordinates the recording of failed speech recognition attempts and the cross-referencing of such failed speech recognition attempts against geographic regions, as well as the updating of speech recognition engines with the recorded failed speech attempts to create speech recognition algorithms with region specific speech input capabilities.

Communication services manager 174 sends to or receives from one or more communication services databases 176 data transmissions via network system 180. Voice recognition manager 236 could be in communication with call center 170 for example over network system 180. In one example, all or part of voice recognition manager 236 is embedded within telematics unit 120.

Voice recognition database 248 is any suitable database for storing information about speech input received from mobile vehicle 100. For example, voice recognition database 248 stores individual recorded calls and speech input related to these calls. Voice recognition database 248 also stores recorded speech recognition failures cross-referenced, for example, by geographic region of the user. Additionally, voice recognition database 248 stores or accesses registration information about telematics unit 120 such as information registering the geographic location of the owner of telematics unit 120 or such as user-designated preferences for a particular speech recognition engine. Moreover, voice recognition database 248 stores or accesses GPS information on telematics unit 120.

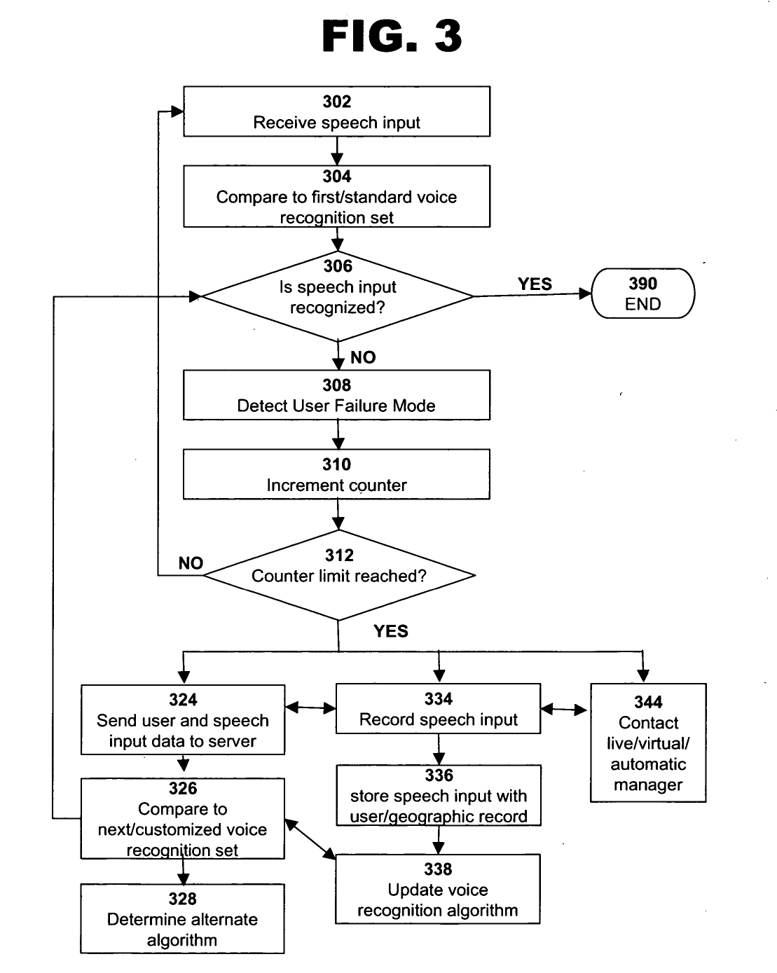

FIG. 3 provides a flow chart 300 for an example of customizing speech recognition in accordance with one example of the current invention. Method steps begin at 302.

Although the steps described in method 300 are shown in a given order, the steps are not limited to the order illustrated. Moreover, not every step is required to accomplish the method of the present invention.

At step 302, the system of the present invention receives speech input. This speech input is received, for example, at telematics unit 120. In one example of the invention, the speech input is the command “dial” followed by a series of spoken numbers.

At step 304, the speech input is compared to a first voice recognition set. This first voice recognition set is evaluated using a typical speech recognition algorithm. One example of a typical speech recognition algorithm is a Hidden Markov Model (HMM). In HMM based speech recognition, the maximum likelihood estimation (MLE) is a popular method. Utilizing MLE, the likelihood function of speech data is maximized over the models of given phonetic classes. The maximization is carried out iteratively using either Baum-Welch algorithm or the segmental K-means algorithm, both algorithms well known in the art. A classification error (MCE) can be used to minimize the expected speech classification or recognition error rate. MCE is also known in the art and has been successfully applied to a variety of popular structures of speech recognition including the HMM, dynamic time warping, and neural networks. The first voice recognition set and its associated speech algorithm are resident at one or more of the following: telematics unit 120, call center 170, communications service manager 174, communications services database 176 or voice recognition manager 236.

At step 306, the system determines if the speech input is recognized. This is generally accomplished by determining if the speech input matches any member of the first voice recognition set. Thus, for example, the speech input “one” is compared to the standardized speech pattern “one”, which is part of the first voice recognition set. The system may also determine if the speech input is associated with a specific instruction, such as “dial” by matching the speech input to a standardized speech pattern “dial” that is part of the original voice recognition set.

If the speech input is recognized, the method ends at step 390. Generally, this recognition occurs when the spoken speech input matches a member of the first voice recognition set.

If the speech input is not recognized, the method proceeds to step 308 wherein a user failure mode is detected. In one user failure mode, the system will ask the user to repeat the input, prompting the user, for example with the query “pardon?” If the system still does not recognize the repeated input, the system will count the input as mis-recognized and will proceed to step 310. In another user failure mode, the system will then provide the user with a likely match and ask the user to confirm it. Thus, for example, the user says “seven”. The system misrecognizes the seven as a match for the “one” of the standardized speech pattern set. In user failure mode, the system then responds to the user with the query “Are you saying the number ‘one’?” If the user says “no” in response to the failure mode query, the system will count the input as mis-recognized and will proceed to step 310.

At step 310, a counter is incremented to count the number of times the speech input is mis-recognized, i.e. does not match any member of the first voice recognition set and is not confirmed by the user. Thus, if the counter limit is set to three, this indicates that the speech input has not been recognized three times (i.e. three mis-recognitions have occurred). This counter helps to eliminate the possibility that noise interference or mechanical problems are causing the mis-recognitions For example, a first and only instance of mis-recognition could be the result of mechanical failure but several repeated mis-recognitions indicate either noise interference or a speech recognition problem. Moreover, on-board diagnostics associated with system 100, 200 will diagnose mechanical failure.

In one example, three mis-recognitions are considered the result of a speech recognition problem rather than noise interference or mechanical difficulty. In another example, the number of mis-recognitions may be configurable. The counter is resident at one or more of the following: telematics unit 120, call center 170, communications service manager 174, communications services database 176, voice recognition manager 236 or voice recognition database 248.

At step 312, the system determines if the counter limit has been reached. If the counter limit has not been reached, the system returns to step 306 and continues to attempt to recognize the speech input. If the counter limit is reached, a number of steps occur simultaneously or in sequence in order to customize the speech recognition based on the speech input. Generally, these various steps comprise manners of alerting the mobile communication system that a failed speech recognition attempt has occurred. This enables the system to respond to the user's request in a timely and efficient manner. At the same time or at a later time, the system is also able to customize its ability to recognize the particular individual's speech patterns.

According to one example of the invention, at step 324, the speech input is sent to a server marked with an identifier that associates the input with the particular user, or the particular telematics unit. In one example the identifier also indicates a geographic region to which the user belongs. In some cases, the speech input is also associated with a particular machine instruction, such as “dial”.

At step 326, another voice recognition set is found by searching a database, for example, communications services database 176 or voice recognition database 248 using the identifier determined at step 324. This next voice recognition set serves as an alternative to the standard voice recognition set. In one example of the invention, this identifier designates a user record that includes information about the individual user, including a record of speech mis-recognitions. This identifier also designates a user-specific voice recognition set that has been uniquely created for the user based on previously determined speech patterns. Alternatively the identifier designates a geographic specific voice recognition set (for example, a voice recognition set for European English speakers or a voice recognition set for English speakers from the North American South or a voice recognition set for English speakers from New York).

At step 328, an alternative algorithm is downloaded to telematics unit 120. In one example of the invention, the algorithm is determined based on the next voice recognition set found at step 326. In another example, the system prompts the user to use a nametag (for example, by asking “what is the name of the person whose number you want me to dial?”) In yet another example, the system prompts the user to alternate means of pronouncing the voice recognition phrase. For example, if the speech recognition engine cannot discriminate between the utterances “home” and “Mom”, where the user intends “Mom”, an alternate pronunciation for “Mom” may be “Mother”. In one example, therefore, the iterative alternate algorithm downloaded at step 328 is based on additional user input.

Meanwhile, at step 334, the speech input is simultaneously recorded (while steps 326 and 328 occur) or is recorded after the alternative voice recognition set and algorithm have been downloaded. The input is recorded, for example, as a .wav file or any suitable audio data file. The input is recorded or stored at one or more of the following: telematics unit 120, call center 170, communications service manager 174, communications services database 176, voice recognition manager 236 or voice recognition database 248. The input is recorded for example, at the microphone of telematics unit 120.

At step 336, the speech input is stored in association with a user record that is unique to the individual user. Such a user record is created once the first instance of mis-recognized speech input has been recorded at step 334. As described above the user record includes information about the individual user, including a record of speech mis-recognitions. The user record is also associated with a user-specific voice recognition set that has been uniquely created for the user based on previously determined speech patterns. Moreover, the user record is also associated with a geographic region specific voice recognition set (for example, a voice recognition set for European English speakers or a voice recognition set for English speakers from the North American South or a voice recognition set for English speakers from New York). Thus two or more data records from the same region can be used to create the geographic region specific voice recognition set. This is accomplished by looking for matching failed speech recognition attempts in a plurality of the data records from the same region and updating the geographic region specific voice recognition set with, for example, the most common mis-recognitions.

Other statistics associated with the user record include the failure/success rate of speech recognition of a particular voice-recognition engine, or the geographic areas where the voice-recognition engine does/does not work well, as well as particular key words that work better with a specific user or in a specific geographic area (for example, whether a New Yorker's speech pattern is more often recognized when she says “dial number” rather than “dial”.) These statistics are extrapolated, for example, at voice recognition manager 236 to create a geographic region specific voice recognition set as well as a geographic region specific voice recognition algorithm/engine.

At step 338, the speech input is used to update a user voice recognition algorithm. For example, the algorithm is updated based on the data about the user's failure mode, or based on the recorded speech pattern. This updated algorithm is sent to the telematics unit associated with the user for improved speech recognition. The updated algorithm may also be created or implemented according to geographic region as described above. Two or more data records from the same region can be used to create the geographic region specific voice algorithm. This is accomplished by looking for matching failed speech recognition attempts in a plurality of the data records from the same region and modifying the algorithm accordingly. This modified algorithm is then one of the possible algorithms available for download at step 328.

In another example of the invention, at step 344, the system automatically contacts a live, virtual or automatic voice recognition manager/advisor so that the command indicated by the speech input is executed in a timely manner.

In one example, the system contacts the manager/advisor with a popup screen that indicates to the advisor that the customer is having problems with a specific command. The advisor/manager confirms the problems, in some instances via a live dialogue with the customer. Based on the interaction between advisor and customer, the call center sends an alternative, or modified, voice recognition engine to telematics unit 120.

In another example, the system contacts the manager/advisor with a list of mis-recognitions. These mis-recognitions could be matched against a database as described above in order to determine an alternative speech recognition engine.

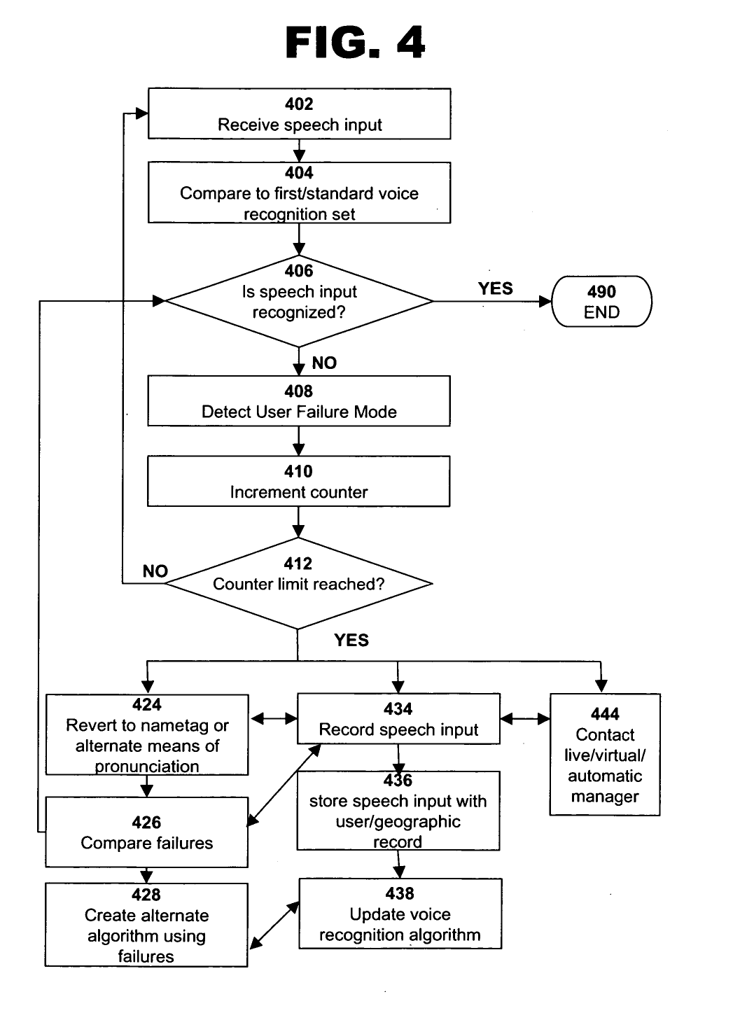

FIG. 4 provides a flow chart 400 for an example of customizing speech recognition in accordance with one example of the current invention. Method steps begin at 402.

Although the steps described in method 400 are shown in a given order, the steps are not limited to the order illustrated. Moreover, not every step is required to accomplish the method of the present invention.

At step 402, the system of the present invention receives speech input. This speech input is received, for example, at telematics unit 120. In one example of the invention, the speech input is the command “dial” followed by a series of spoken numbers.

At step 404, the speech input is compared to a first voice recognition set. This first voice recognition set is based on a standardized speech recognition algorithm as described above. The first voice recognition set and the speech algorithm are resident at one or more of the following: telematics unit 120, call center 170, communications service manager 174, communications services database 176 or voice recognition manager 236.

At step 406, the system determines if the speech input is recognized. This is accomplished, in one example, by determining if the speech input matches any member of the first voice recognition set. Thus, for example, the speech input “one” is compared to the standardized speech pattern “one”, which is part of the first voice recognition set. The system may also determine if the speech input is associated with a specific instruction, such as “dial” by matching the speech input to a standardized speech pattern “dial” that is part of the original voice recognition set.

If the speech input is recognized, the method ends at step 490. In one example, this recognition occurs when the spoken speech input matches a member of the first voice recognition set.

If the speech input is not recognized, the method proceeds to step 408 wherein a user failure mode is detected and implemented as described above at 308.

At step 410, a counter is incremented to count the number of times the speech input is mis-recognized, i.e. does not match any member of the first voice recognition set and is not confirmed by the user. As described above at 310, the counter is resident at one or more of the following: telematics unit 120, call center 170, communications service manager 174, communications services database 176, voice recognition manager 236 or voice recognition database 248.

At step 412, the system determines if the counter limit has been reached. If the counter limit has not been reached, the system returns to step 406 and continues to attempt to recognize the speech input. If the counter limit is reached, a number of steps occur simultaneously or in sequence in order to customize the speech recognition based on the speech input. This enables the system to respond to the user's request in a timely and efficient manner. At the same time or at a later time, the system is also able to customize its ability to recognize the particular individual's speech patterns.

According to this example of the invention, at step 424, the system prompts the user to use a nametag (for example, by asking “what is the name of the person whose number you want me to dial?”) In yet another example, the system prompts the user to try alternate means of pronouncing the voice recognition phrase, such as prompting the user to say “Mother” rather than “Mom”.

Meanwhile, at step 434, the speech input is recorded. The input is recorded, for example, as a .wav file or any suitable audio data file such as an .mp3, .aac, .ogg etc. The input is recorded or stored at one or more of the following: telematics unit 120, call center 170, communications service manager 174, communications services database 176, voice recognition manager 236 or voice recognition database 248. The input is recorded for example, through the microphone of telematics unit 120.

At step 426, the failure (speech input mis-recognized and recorded at step 434) is compared to the successfully recognized phrase identified by the user at step 424.

At step 438, the compared failures of step 426 are used to update a user voice recognition algorithm. This updated algorithm is sent to the telematics unit associated with the user for improved speech recognition. Additionally, the user voice recognition algorithm may be cross-referenced according to geographic area with an algorithm for a specific geographic region.

Thus the iterative alternate algorithm downloaded at step 428 is then created according to the failed speech recognition attempts

Meanwhile, at step 436, the speech input is stored in association with a user record that is unique to the individual user. Such a user record is created once the first instance of mis-recognized speech input has been recorded at step 334. As described above, the user record includes information about the individual user, including a record of speech mis-recognitions. The user record is also associated with a user-specific voice recognition set that has been uniquely created for the user based on previously determined speech patterns. The user record is also associated with a geographic specific voice recognition set (for example, a voice recognition set for European English speakers or a voice recognition set for English speakers from the North American South or a voice recognition set for English speakers from New York).

Other statistics associated with the user record include the failure/success rate of speech recognition of a particular voice-recognition engine, or the geographic areas where the voice-recognition engine does/does not work well, as well as particular key words that work better with a specific user or in a specific geographic area (for example, whether a New Yorker's speech pattern is more often recognized when she says “dial number” rather than “dial”.)

In another example of the invention, at step 444, the system automatically contacts a live, virtual or automatic voice recognition manager/advisor so that the command indicated by the speech input is executed in a timely manner. Once this advisor has been contacted, the other steps of the inventions (424, 426, 428, 434, 436, and 438) are accomplished in order to generate a new voice recognition algorithm based on the dialogue that the advisor has with the user.

While the examples of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

What is claimed is:

1. A method of customizing speech recognition in a mobile vehicle communication system, comprising:
receiving a speech input at a telematics unit in communication with a call center, the speech input associated with a failure mode notification;
recording the speech input at the telematics unit;
forwarding the recorded speech input to the call center via a wireless network based on the failure mode notification; and
receiving at least one user-specific voice-recognition set from the call center in response to the failure mode notification, wherein the user-specific voice-recognition set has been updated with the speech input.

2. The method of claim 1, further comprising:
determining a machine instruction responsive to the speech input; and updating the user-specific voice-recognition set based on the determined machine instruction and speech input.

3. The method of claim 1, further comprising:
receiving a voice recognition algorithm at the telematics unit from the call center, wherein the voice recognition algorithm incorporates data from the speech input.

4. The method of claim 3 further comprising:
associating the user-specific voice-recognition set with a geographic designation.

5. The method of claim 4, further comprising:
determining a geographic region of the telematics unit; and
updating a geographically-specific voice recognition set based on the determined geographic region and speech input.

6. The method of claim 4, further comprising:
selecting the user-specific voice recognition set based on registration information of the telematics unit.

7. The method of claim 4, further comprising:
receiving a geographically-specific voice recognition algorithm from the call center, wherein the geographically-specific voice recognition algorithm incorporates data from the speech input.

8. A method of customizing speech recognition in a mobile vehicle communication system, comprising:
receiving a failure mode notification from a telematics unit via a wireless network, wherein the failure mode notification includes a recorded speech input;
associating the speech input with a machine instruction;
updating a user-specific voice recognition set with the speech input, wherein the updating comprises associating the speech input with a geographic designation; and
forwarding the updated user-specific voice recognition set to the telematics unit.

9. The method of claim 8, further comprising:
modifying a voice recognition algorithm based on data from the speech input.

10. The method of claim 9, further comprising:
forwarding the modified voice recognition algorithm to the telematics unit.

11. The method of claim 8, further comprising:
creating the geographic designation for the telematics unit.

12. The method of claim 11 wherein the geographic designation is based on a factor selected from the group consisting of:
a geographic location of the telematics unit, registration information of the telematics unit; and a global positioning location of the telematics unit.

13. A computer usable medium including a program to customize speech recognition in a mobile vehicle communication system, comprising:
computer program code that receives a failure mode notification from a telematics unit via a wireless network, wherein the failure mode notification includes a recorded speech input;
computer program code that associates the speech input with a machine instruction;
computer program code that updates a user-specific voice recognition set with the speech input, wherein the user-specific voice recognition set is associated with a geographic region; and
computer program code that forwards the updated user-specific voice recognition set to the telematics unit.

14. The program of claim 13, further comprising:
computer program code that modifies a voice recognition algorithm based on data from the recorded speech input.

15. The program of claim 14, further comprising:
computer program code that forwards the modified voice recognition algorithm to the telematics unit.

16. The program of claim 13, further, comprising:
means for determining a machine instruction responsive to the speech input.

17. The program of claim 14, further comprising:
means for creating the geographic designation for the telematics unit.

18. The program of claim 14, further comprising:
means for determining a geographic location of the telematics unit;
means for determining registration information of the telematics unit; and
means for determining a global positioning location of the telematics unit.

19. The program of claim 14, further comprising:
means for determining a geographic region of the telematics unit; and
means for selecting the user-specific voice recognition set based on the geographic region.

20. The program of claim 14, further comprising:
computer program code that selects the user-specific voice recognition set based on registration information of the telematics unit.
